(19) United States
(12) Patent Application Publication
(10) Pub. No.: US 2005/0180268 A1
(43) Pub. Date: Aug. 18, 2005

(54) Clock with an inserted base

(76) Inventors: Nobuyuki Yamazaki, Tokyo (JP); Hisae Yamashita, Tokyo (JP)

Correspondence Address: DILWORTH & BARRESE, LLP, 333 EARLE OVINGTON BLVD., UNIONDALE, NY, 11553, US

(21) Appl. No.: 11/021,122

(22) Filed: Dec. 23, 2004

Related U.S. Application Data
(63) Continuation-in-part of application No. 10/465,699, filed on Jun. 19, 2003.

(51) Int. Cl. G04B 37/00

(52) U.S. Cl. 368/276

(57) ABSTRACT

A clock with an inserted base is provided to facilitate presenting various illustrations such as photographs, advertising copy, logos, etc., upon the surface of the clock face after purchase by a customer. The base is separately provided apart from the clock and then inserted into and coupled to the main clock frame which is then supported upon the base in upright position. In a preferred embodiment, the base is composed of a cover and insert rotatably coupled together so that the main clock frame is shielded by the cover in closed condition and supported upon the cover in open condition.

### CROSS REFERENCE TO RELATED APPLICATIONS

The present application is a continuation-in-part of copending U.S. application Ser. No. 10/465,699 filed Jun. 19, 2003, the contents of which are incorporated by reference herein.

### BACKGROUND OF THE INVENTION

The present invention is directed to a clock having a base which can be inserted into a main body frame of the clock after molding and be securely coupled thereto.

Visual features such as logos or characters have been printed upon faces or hour plates of conventional clocks before assembly, at the clock factory itself. This has undesirably increased cost per unit manufacture because of expenditures for providing printing blocks and the actual steps of printing upon the clock faces. Costs especially increase when only a small shipment of specialty clocks with unique clock faces are ordered. Additionally, the entire clock had to be assembled right at the clock factory, adding to increase expense in manufacturing and shipping where delicate protruding parts, such as a base frame, could break unless especially packed during shipping.

It is desirable to allow a purchaser of a clock to place their own visual display, e.g., a decal, upon the face of a clock. This has not been possible once components of a clock had been assembled together, necessitating cumbersome disassembly. At the same time, it is necessary to provide a stable secure base upon which a timepiece can be rested to display time.

Accordingly, it is an object of the present invention to enhance display of time.

It is also an object of the present invention, to improve assembly and shipping of a timepiece such as a clock.

It is an additional object of the present invention to improve visual display upon a time piece such as a clock.

It is a further object of the present invention to improve coupling of components forming a timepiece such as a clock together to improve visual display of time.

It is a more specific object of the present invention to improve shipping of a timepiece such as a clock to reduce danger of breakage.

It is another object of the present invention to improve versatility in display of time by improving ease with which a unique visual display can be provided upon the face of a timepiece.

It is yet another object of the present invention to reduce expenditures of manufacturing a clock, especially where the clock is required for different, special uses.

### SUMMARY OF THE INVENTION

These and other objects are attained by the present invention which is directed to a clock with an insertion base which is separately manufactured, e.g., molded, apart from the main body frame of the clock and then coupled to the clock in secure fashion. The insertion base can be provided with a visual illustration, e.g., by a purchaser such as a consumer, importer, wholesaler, and then coupled to the main body frame such that the visual illustration is easily displayed upon the flat clock face being flush with a front face of the insertion base. The clock can then be rested uprightly upon the base which securely and stably supports the same. There is no danger of the clock main body frame and insertion base becoming detached from one another once the two components are securely coupled together.

With the present invention, the main body frame and insertion base can be separately packaged and shipped, reducing cost of assembly and further protecting the components during shipping. Unique visual indicia can be placed by a customer upon each clock face, reducing cost per unit especially where the same type of clock is required for different uses. Need to provide printing and accompanying printing blocks at the manufacturing site has been eliminated.

In a preferred embodiment, the insertion base comprises two components rotatably coupled to one another, such that one of the components can be rotated to cover the clock face when not in use. When the clock is to be used, the cover component is simply rotated around a pivot axis or pin coupling the two components of the base together, e.g., over an approximate 270° angle, to form a base supporting the clock.

### BRIEF DESCRIPTION OF THE DRAWINGS

The present invention will be described in greater detail with reference to the accompanying drawings in which

FIG. 1 illustrates a perspective view of the clock with an inserted base according to the present invention in assembled condition;

FIG. 2 illustrates an exploded view illustrating the various components of the clock and inserted base in structural relationship to one another;

FIG. 3A illustrates a front elevational view of the clock with inserted base in assembled condition;

FIG. 3B illustrates a top plan view, partially in section, of the clock and base shown in FIG. 3A along line 3B-3B of FIG. 3A;

FIG. 4 illustrates a right side elevational view, partially in section, of the clock and base shown in FIGS. 3A and 3B and along line 4-4 in FIG. 3A;

FIG. 5 illustrates a rear elevational view of the clock and base shown in FIGS. 3A, 3B, and 4;

FIG. 6 illustrates a left side elevational view of the clock and base shown in FIGS. 3A, 3B, 4 and 5;

FIG. 7 is a front elevational view, similar to FIG. 3A, and illustrating an alternative embodiment of the clock with an inserted base in which the outer frame of the clock body has a tetragonal or quadrilateral shape;

FIG. 8 is a front elevational view, similar to FIGS. 3A and 7, and illustrating a further alternative embodiment of the clock with an inserted base in which the outer frame of the clock body has a triangular shape;

FIG. 9 is a front elevational view, similar to FIGS. 3A, 7 and 8 and illustrating another alternative embodiment of the clock with an inserted base, in which this the inserted base has a quadrilateral or trapezoidal shape;

FIG. 10 is a front elevational view similar to FIGS. 3A and 7-9 and illustrating yet a further alternative embodiment of the clock with an inserted base, in which the inserted as has a concave or kidney shape;

FIG. 11, is a front elevational view similar to FIGS. 3A and 7-10 and illustrating still another alternative embodiment of the clock with an inserted base, in which the inserted base has a convex protruding shape;

FIG. 12 is a front elevational view also illustrating an inserted base of quadrilateral or trapezoidal shape but with different extension from FIG. 9;

FIG. 13 illustrates a perspective view of the clock with an inserted base according to an alternative embodiment of the present invention, in assembled condition;

FIG. 14A schematically illustrates a right side elevational view, partially in section, of coupling of components to form the clock with the inserted base shown in FIG. 13;

FIG. 14B illustrates a right side elevational view, in closed condition, of the clock with inserted base shown in FIG. 13;

FIG. 14C illustrates a right side elevational view, partially in section, of the clock with inserted base shown in FIG. 13 and in open condition;

FIG. 15 respectively illustrates top plan, front elevational and bottom plan views of the main body frame of the clock without the base inserted thereinto;

FIG. 16 schematically illustrates rotatable coupling of the components forming the base to be inserted into the main body frame of the assembled clock shown in FIG. 13;

FIG. 17 illustrates a front elevational view of the cover for the clock; and

FIGS. 18A and 18B respectively illustrated right side elevational views of the cover and insertion components forming the base of the clock shown in FIG. 16.

### DESCRIPTION OF THE PREFERRED EMBODIMENTS

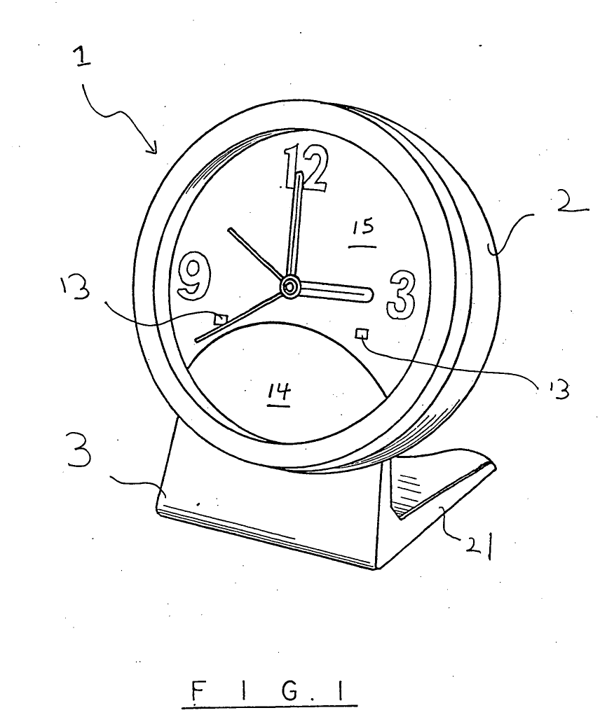

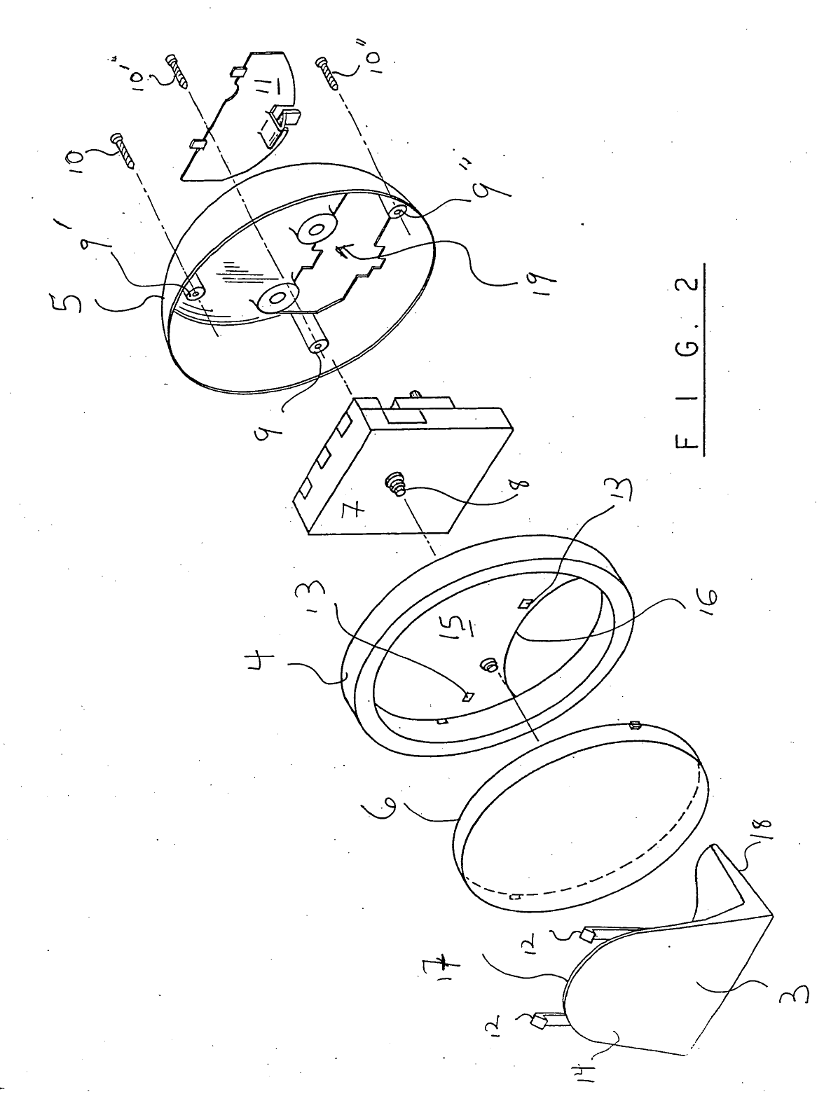

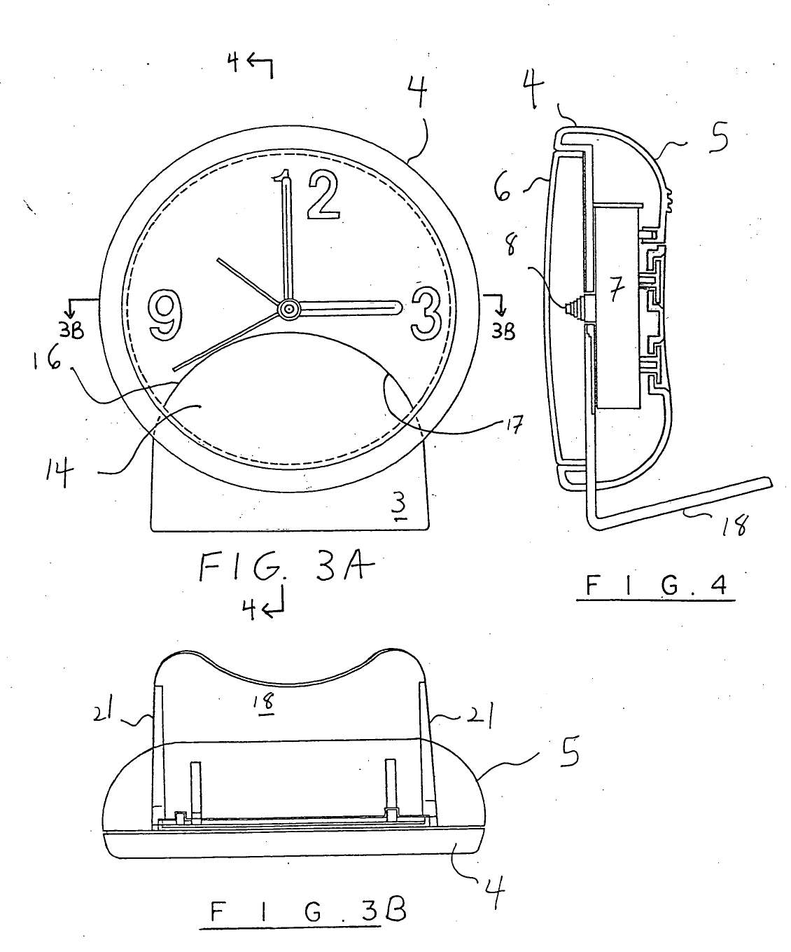

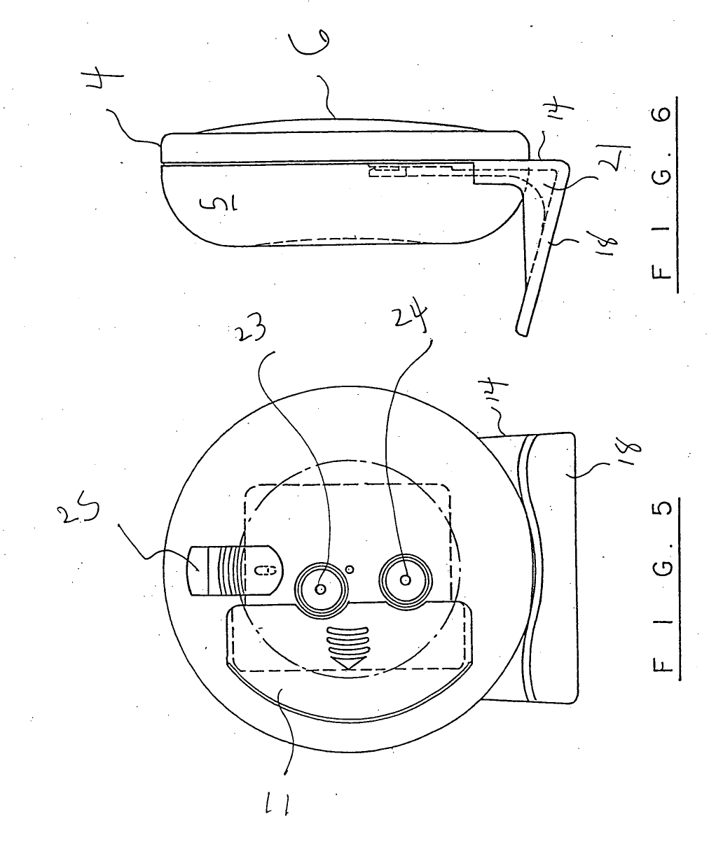

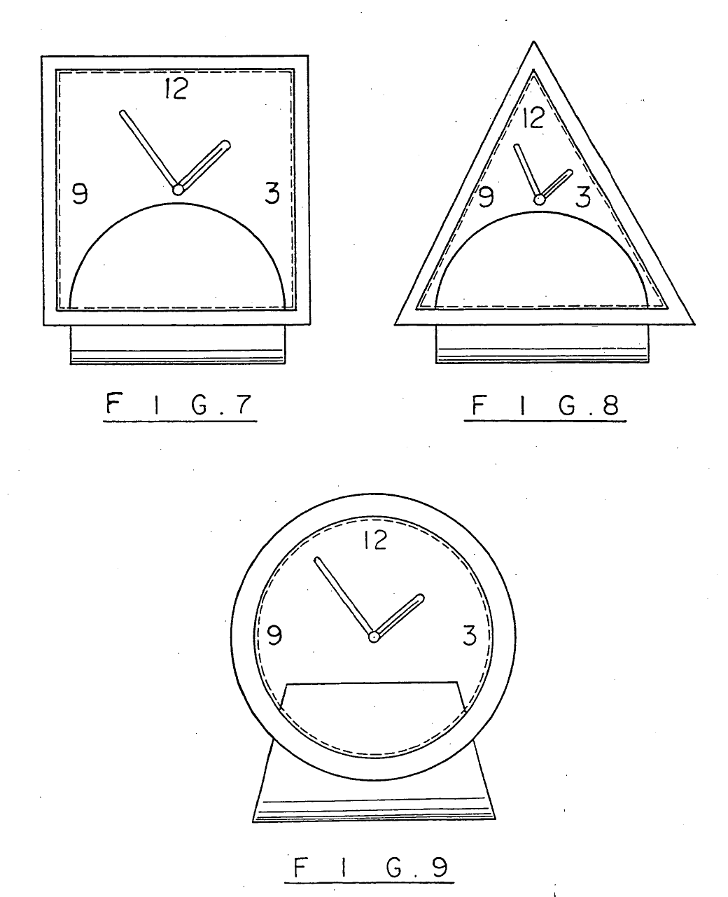

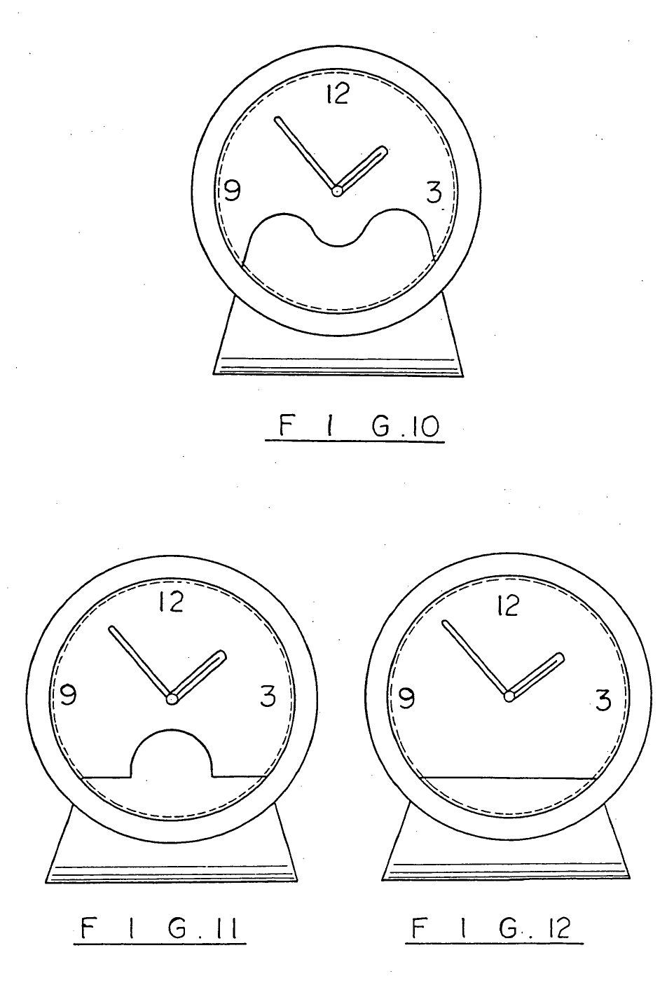

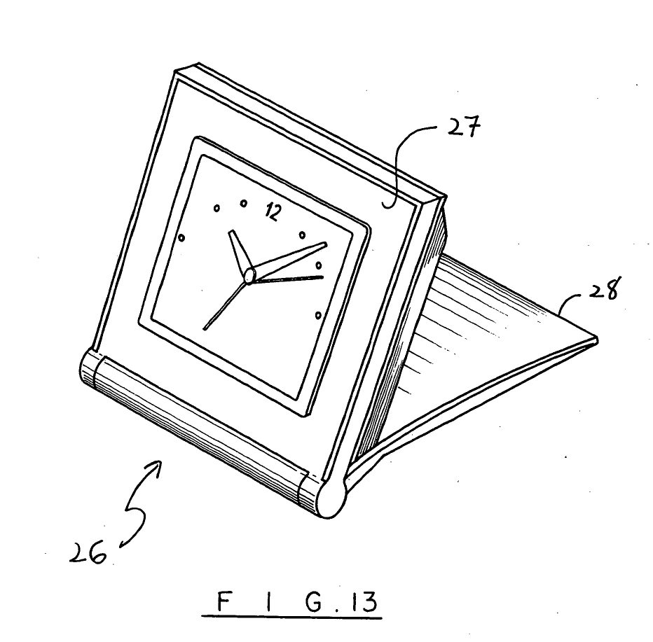

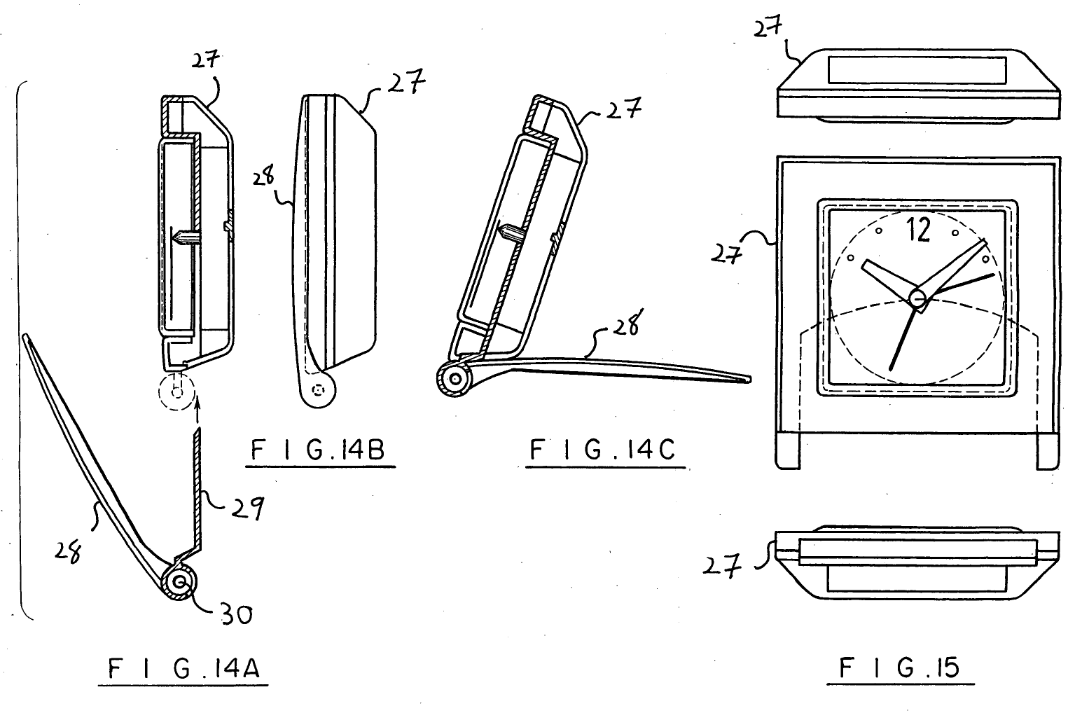

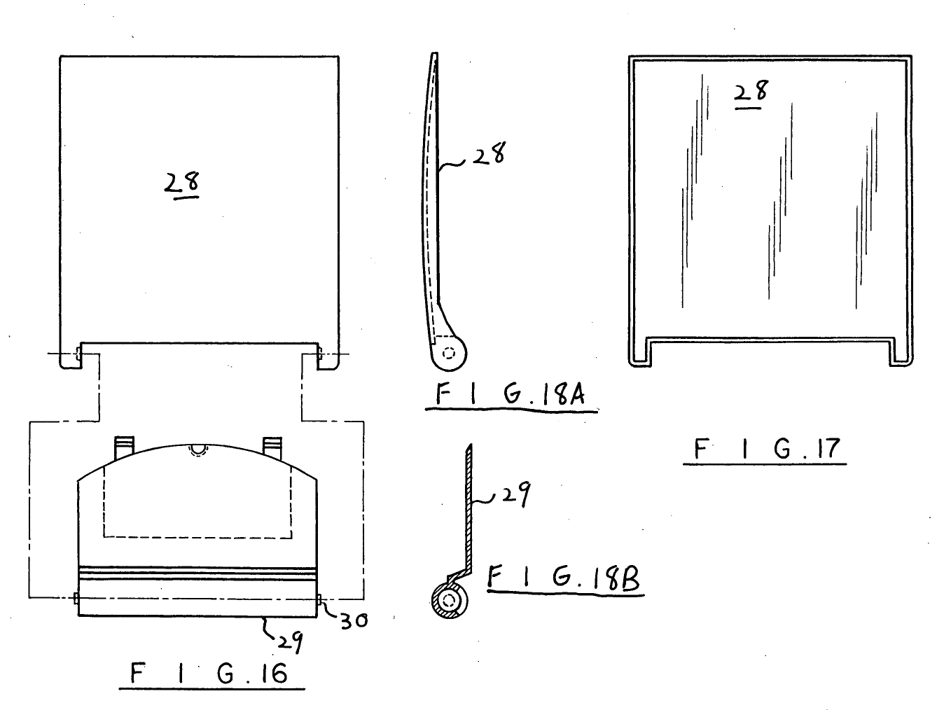

The clock 1 with an insertion base is shown in the perspective view of FIG. 1 as comprising a main body frame 2 and separate insertion base 3. As best seen in the exploded view of FIG. 2, the main frame body 2 comprises a front side or face 4 and a rear side or face 5 that are held together by screws 10, 10′, 10″ being threaded into respective raised bore holes 9, 9′, 9″. A clockwork mechanism 7, containing gears, is seated within and retained by main body members 4 and 5 of the main body frame 2 when coupled together, and comprises a spindle 8 rotatably extending therefrom and protruding through the hour plate or clock face 15 supported upon the front main frame member 4. The various pointers, e.g. hour, minute and second hands and an alarm-setting pointer, are rotatably positioned upon the spindle 8. Time and the alarm can be set by appropriately rotating spindles 23 and 24 protruding from the rear of the clockwork mechanism 7 and through the rear face 5 of the clock main frame 2 as best seen in FIG. 5. The alarm, e.g. a sound alarm such as a buzzer, can be activated in the clockwork mechanism 7 by sliding the switch 25 found upon the rear face 5 of the main frame body 5. Additionally, appropriate numerals can be placed upon the clock face 15 as illustrated.

The insertion base 3 is initially provided apart from the main frame body 2 as illustrated in FIG. 2. In the illustrated embodiment, the insertion base 3 comprises a front face 14 facing forwardly when uprightly positioned and an approximately normal extension 18 to form an approximately L-shaped base 3. In the illustrated embodiment, the normal extension comprises webs or wings 21 on lateral sides thereof as illustrated. The base 3 comprises an upper convexly curved edge 17 on top of the front face 14, while the clock face 15 of the main frame body comprises a lower, substantially complementary concavely curved edge 16 designed to mate with the upper edge 17 of the insertion base 3 to form a flat, flush surface when the base 3 and main frame body 2 are coupled together as shown.

In this regard, the insertion base 3 is provided with a pair of hooks 12, 12 designed to be inserted into corresponding openings 13, 13 found in the clock face 15 from a direction opposite to viewing the clock face 15 when assembled. Thus, when the base 3 and main frame body 2 are assembled together, a single, flush surface of the clock face 15 and front face 14 of the insertion base 3 is presented for viewing.

Concerning other components, reference numeral 6 denotes a transparent plastic or glass cover, while a battery can be inserted into the clockwork mechanism 7 through opening 19 in the rear frame member 5. The opening 19 is then closed by a resilient clip member 11 as shown.

In assembling, the front face 14 of the base 3 can first be provided with a visual display, e.g. a decal, logo, advertising copy, picture, photograph, etc. After the appropriate visual display has adhered to the front face 14 of the base 3, then the base 3 is simply inserted up through an opening or slot in the main body frame 2 (defined between the front 4 and rear 5 frame members), and sufficiently upwardly to allow hooks 12, 12 to snap into engagement with openings 13, 13 provided in the clock face 15 from a direction behind the clock face 15, i.e., on a side of the clock face 15 opposite the viewing direction. The base 3 and main body frame 2 are thus permanently coupled together to form a single flush surface that allows unimpeded rotation of all pointers rotatably mounted upon the spindle 8 protruding through the clock face 15. The clock 1 can then be simply rested upon the normally-extending member 18 of the base 3 which securely supports the clock 1, including all clockwork mechanisms 7, etc., in stable, upright, manner.

The clock and base of the present invention can be manufactured from any appropriate material, e.g. hard plastic, such as by appropriate molding. The clock body 1 has been illustrated with substantially circular shape in FIGS. 1-6. but may also have a substantially tetragonal or quadrilateral shape as illustrated in FIG. 7 or even a triangular shape as illustrated in FIG. 8. Furthermore, the inserted base itself, may take any of a variety of shapes, e.g., quadrilateral or trapezoidal having different extension (FIGS. 9 and 12), concave or kidney-shaped (FIG. 10), and convex-shaped (FIG. 11), with the clock face itself being appropriately complementarily-shaped to ensure proper mating of adjacent surfaces upon engagement as illustrated.

The alternative embodiment of the clock 26 with the inserted base illustrated in FIGS. 13-18B is similar to the embodiments shown in FIGS. 1-12, except the base is not integrally formed as a single piece, but is rather composed of two separate components, a cover 28 and insertion portion 29, rotatably coupled together about a pin or axis 30. Then, the insertion portion 29 is inserted into the main body frame 27 of the clock 26 in similar fashion to the embodiments shown in FIGS. 1-12, with the respective hooks engaging respective openings in the clock face. FIG. 14A illustrates inserting the insertion portion 29 within the main body frame 27 of the clock after the cover 28 and insertion portion 29 have been coupled together about axis or pin 30. The clock 26 is shown in closed condition in FIG. 14B, i.e., with the cover 28 closed over the clock face. When in use, the cover 28 is simply rotated about the axis or pin 30 to the position shown in FIG. 14C, where the cover 28 forms a supporting base for the clock 26. Coupling of the insertion portion 29 and cover 28 about pin or axis 30 is illustrated in FIG. 16. In other respects, the embodiment shown in FIGS. 14-18B is identical in operation and function to the embodiments shown in FIGS. 1-12.

The preceding description of the present invention is merely exemplary and is not intended to limit the scope thereof in any way.

1. A clock with an insertion base, comprising
a main body frame of the clock structured and arranged to support a clock face and contain a clockwork mechanism for showing current time upon the clock face,
said main body frame comprising an insertion opening at a lower end thereof,
an insertion base separately provided apart from said main body frame and structured and arranged to be inserted into said insertion opening of said main body frame,
said insertion base comprising a cover member and an insertion portion for insertion into said insertion opening of said main body frame,
said cover member and insertion portion being rotatably coupled together, such that after assembly, said cover member can be rotated with respect to said insertion portion and main body frame to either cover the clock face in closed condition, or form a support base for the clock in open condition, with an inner surface of the cover member in closed condition forming a support surface in open condition.

2. The combination of claim 1, wherein said insertion base comprises a front face structured and arranged to receive illustrations such as logos, advertising copy, photographs, etc. and display the same when secured to the main body frame.

3. The combination of claim 2, wherein said front face of said insertion portion is situated flush with the clock face upon insertion into and securing to said main body frame.

4. The combination of claim 1, wherein said insertion portion and cover member form a substantial L-shape in open condition to thereby support said main body frame of said clock when secured to said base and arranged in upright position.

5. The combination of claim 1, additionally comprising a pointer or pointers coupled to said clockwork mechanism through the clock face and arranged to rotate about the clock face to show current time, including rotating about the insertion portion when coupled to said main body frame.

6. The combination of claim 2, additionally comprising a pointer or pointers coupled to said clockwork mechanism through the clock face and arranged to rotate about the clock face to show current time, including rotating about said front face of said insertion portion when coupled to said main body frame.

7. The combination of claim 3, additionally comprising a pointer or pointers coupled to said clockwork mechanism through the clock face and arranged to rotate about the clock face to show current time, including rotating about said front face of said insertion portion when coupled to said main body frame.

8. The combination of claim 1 wherein said coupling components comprise
an opening in the clock face, and
at least one hook attached to said insertion base and structured and arranged to seat in said clock face opening on a side away from viewing.

9. The combination of claim 8, comprising
two openings in the clock face, and
two hooks positioned upon said insertion portion and structured and arranged to seat in a respective one of said clock face openings upon coupling.

10. The combination of claim 2, wherein said coupling components comprise
a plurality of openings in the clock face, and
two hooks positioned upon said insertion base and structured and arranged to seat in a respective one of said clock face openings on a side away from viewing upon coupling.

11. The combination of claim 1, wherein an upper edge of said insertion portion and a lower edge of said clock face are substantially complementary shaped to provide a single flat visual display surface upon coupling.

12. The combination of claim 2, wherein said flat front face of said insertion portion comprises an upper, convexly curved edge and a lower edge of said clock face is concavely curved,
with said respectively edges being substantially complementary shaped with respect to one another to form a substantially flat visual display surface upon coupling.

13. The combination of claim 11, wherein said coupling components comprise
a plurality of openings in the clock face, and
two hooks positioned upon said insertion portion and structured and arranged to seat in a respective one of said clock face openings on a side away from viewing upon coupling.

14. The combination of claim 12, wherein said coupling components comprise
a plurality of openings in the clock face, and
two hooks positioned upon said insertion portion and structured and arranged to seat in a respective one of said clock face openings on a side away from viewing upon coupling.

15. The combination of claim 1, wherein the clock body is substantially circular, quadrilateral or triangular in shape.

16. The combination of claim 2, wherein the clock body is substantially circular, quadrilateral or triangular in shape.

17. The combination of claim 3, wherein the clock body is substantially circular, quadrilateral or triangular in shape.

18. The combination of claim 4, wherein the clock body is substantially circular, quadrilateral or triangular in shape.

19. The combination of claim 5, wherein the clock body is substantially circular, quadrilateral or triangular in shape.
